(19) United States
(12) Patent Application Publication
(10) Pub. No.: US 2020/0276770 A1
(43) Pub. Date: Sep. 3, 2020

(54) BONDED ASSEMBLIES HAVING LOCKING ORIFICES AND RELATED METHODS

(71) Applicant: Carbon, Inc., Redwood City, CA (US)

(72) Inventor: Mingxi Zheng, San Francisco, CA (US)

(21) Appl. No.: 16/802,080

(22) Filed: Feb. 26, 2020

Related U.S. Application Data
(60) Provisional application No. 62/811,784, filed on Feb. 28, 2019.

(51) Int. Cl. B29C 65/48; B32B 7/12; B32B 3/30; B32B 5/18; B32B 37/12; B33Y 80/00; B29C 65/00; A43D 25/18

(52) U.S. Cl. CPC B29C 65/48; B32B 7/12; B32B 3/30; B32B 5/18; B29L 2031/4821; B33Y 80/00; B29C 66/30325; A43D 25/18; B32B 2437/02; B32B 37/12

(57) ABSTRACT

In some embodiments, a method of forming a bonded assembly includes: providing a first object comprising a first surface having a plurality of locking orifices formed therein, each of the plurality of locking orifices including an opening on the surface of the object and a cavity extending in the first object; positioning an adhesive on at least one of the first surface of the first object and a second surface on a second object; positioning the first surface of the first object on the second surface of the second object with the adhesive between the first and second surfaces; and curing the adhesive to form the bonded assembly.

### RELATED APPLICATIONS

The present application claims priority to U.S. Provisional Application Ser. No. 62/811,784, filed Feb. 28, 2019, the disclosure of which is hereby incorporated by reference in its entirety.

### FIELD OF THE INVENTION

The present invention concerns bonded assemblies having a portion formed by additive manufacturing, and in particularly stereolithography, including continuous liquid interface production (CLIP), with locking orifices therein.

### BACKGROUND OF THE INVENTION

A group of additive manufacturing techniques sometimes referred to as “stereolithography” create a three-dimensional object by the sequential polymerization of a light polymerizable resin. Such techniques may be “bottom-up” techniques, where light is projected into the resin ont the bottom of the growing object through a light transmissive window, or “top down” techniques, where light is projected onto the resin on top of the growing object, which is then immersed downward into the pool of resin.

The recent introduction of a more rapid stereolithography technique known as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and 9,216,546 to DeSimone et al.; and also in J. Tumbleston, D. Shirvanyants, N. Ermoshkin et al., Continuous liquid interface production of 3D Objects, Science 347, 1349-1352 (published online 16 Mar. 2015); see also Rolland et al., U.S. Pat. Nos. 9,676,963, 9,453,142 and 9,598,606).

Manufacturers have adhesives for joining parts (e.g., polymer to a metal, such as a polymer bicycle seat to a composite shell; polymer to fabric, such as a midsole to an upper; polymer to polymer, such as a midsole to an outsole, etc.) that are validated for their particular parts and materials. When one part is replaced with an additively manufactured part, the adhesive may no longer be valid for the now additively manufactured part (though it is still valid for the other, preformed, part).

### SUMMARY OF THE INVENTION

In some embodiments, a method of forming a bonded assembly includes: providing a first object comprising a first surface having a plurality of locking orifices formed therein, each of the plurality of locking orifices including an opening on the surface of the object and a cavity extending in the first object; positioning an adhesive on at least one of the first surface of the first object and a second surface on a second object; positioning the first surface of the first object on the second surface of the second object with the adhesive between the first and second surfaces; and curing the adhesive to form the bonded assembly.

In some embodiments, pressure is applied such that the adhesive flows into the plurality of locking orifices prior to curing the adhesive.

In some embodiments, adhesive flows into the cavity extending in the first object.

In some embodiments, a cross section of the cavity is greater than a cross section of the opening of the plurality of locking orifices.

In some embodiments, each of the plurality of lcoking cavities comprises a channel connecting the opening to the cavity, wherein a cross section of the cavity is greater than a cross section of the channel.

In some embodiments, the adhesive comprises an adhesive selected from the group consisting of polymer adhesives, epoxy adhesives, cyanoacrylate adhesives, polyurethane adhesives, silicone adhsives and combinations thereof.

In some embodiments, the first object is a partially cured object, and wherein curing the adhesive to form the bonded assembly further comprises further curing the first object.

In some embodiments, the bonded assembly comprises a dual-material cushion with the first object comprising a 3D printed lattice structure and the second object comprising foam. In some embodiments, the dual-material padding comprising the first and second object is sized and configured to provide cushioning material for a helmet.

In some embodimetns, the first object of the assembly comprises a protective layer (e.g., a bumper or padding).

In some embodiments, the first object comprises a cushioning lattice structure and the second object comprises a base (e.g., a bike handle grip, a bike seat, a grip cushion for a camera).

In some embodiments, the first object is a shoe midsole and the second object is a shoe upper or a shoe sole.

In some embodiments, the first object comprises first and second opposing sides, and the plurality of locking orifices is on a first side of the first object.

In some embodiments, the plurality of locking orifices is on the second side of the first object, the method further comprising positioning the adhesive on at least one of the second side of the first object and a third surface on a third object such that the adhesive is cured between the first object and the third object to provide the bonded assembly.

In some embodiments, the first object comprises a three-dimensional printed object.

In some embodiments, a bonded assembly includes: a first object comprising a first surface having a plurality of locking orifices formed therein, each of the plurality of locking orifices including an opening on the surface of the object and a cavity extending in the first object; a second object comprising a second surface; and an adhesive between the first and second surfaces, the adhesive extending in the plurality of locking orifices.

### BRIEF DESCRIPTION OF THE DRAWINGS

FIG. 1 schematically illustrates a bottom-up stereolithography apparatus for producing a three-dimensional object by additive manufacturing according to embodiments of the present invention.

FIG. 2 is a cross sectional view of an object having orifices therein according to some embodiments of the present invention.

FIG. 3 is a cross sectional view of an object that may be bonded to the object of FIG. 2.

FIG. 4 is a cross sectional view of a bonded assembly according to some embodiments of the present invention.

FIG. 5 is an exploded view of a shoe assembly that is bonded according to some embodiments of the presented invention.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity. Where used, broken lines illustrate optional features or operations unless specified otherwise.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

### 1. Additive Manufacturing Methods and Apparatus.

Additive manufacturing apparatus and methods are known. Suitable apparatus includes bottom-up apparatus that employ a window, or optically transparent member or “build plate,” on which a pool of polymerizable liquid sits, and through which patterned light is projected to produce a three-dimensional object. Such methods and apparatus are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication Nos. 2013/0292862 to Joyce, and US Patent Application Publication No. 2013/0295212 to Chen et al. The disclosures of these patents and applications are incorporated by reference herein in their entirety.

CLIP is known and described in, for example, U.S. Pat. Nos. 9,211,678; 9,205,601; and U.S. Pat. No. 9,216,546 to DeSimone et al.; and also in J. Tumbleston, D. Shirvanyants, N. Ermoshkin et al., Continuous liquid interface production of 3D Objects, Science 347, 1349-1352 (published online 16 Mar. 2015). See also R. Janusziewcz et al., Layerless fabrication with continuous liquid interface production, Proc. Natl. Acad. Sci. USA 113, 11703-11708 (Oct. 18, 2016). In some embodiments, CLIP employs features of a bottom-up three dimensional fabrication as described above, but the the irradiating and/or the advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. The particular manner of description is not critical, and the present invention can be used in any of a variety of systems that employ a semipermeable build plate, through which an inhibitor of polymerization passes, whether explicitly referred to as “CLIP” or not.

The apparatus can include a local controller that contains and executes operating instructions for the production of a three dimensional object on that apparatus, typically from an object data file entered into the controller by the user. Along with the basic three-dimensional image of the object that is typically projected for photopolymerization (along with movement of the carrier and build surface away from one another in the Z direction), the operating instructions can include or generate process parameters such as: light intensity; light exposure duration; inter-exposure duration; speed of production; step height; height and/or duration of upstroke in a stepped or reciprocal operating mode; height and/or duration of downstroke in a reciprocal operating mode; rotation speed for pumping viscous polymerizable liquid; resin heating temperature; and/or resin cooling temperature; rotation speed and frequency, etc. (see, e.g., Ermoshkin et al., Three-dimensional printing with reciprocal feeding of polymerizable liquid PCT Patent Application Publication No. WO 2015/195924 (published 23 Dec. 2015); Sutter et al., Fabrication of three dimensional objects with multiple operating modes, PCT Patent Application Publication No. WO 2016/140886 (published 9 Sep. 2016); J. DeSimone et al., Methods and apparatus for continuous liquid interface production with rotation, PCT Patent Application Publication No. WO 2016/007495 (published 14 Jan. 2016); see also J. DeSimone et al., U.S. Pat. No. 9,211,678, and J. Batchelder et al., Continuous liquid interface production system with viscosity pump, US Patent Application Publication No. 2017/0129169 (published 11 May 2017).

In one non-limiting embodiment, the apparatus may be a Carbon Inc., M1 or M2 additive manufacturing apparatus, available from Carbon, Inc., 1089 Mills Way, Redwood City, Calif. 94063 USA.

Numerous resins for use in additive manufacturing are known and can be used in carrying out the present invention. See, e.g., U.S. Pat. No. 9,205,601 to DeSimone et al.

In some embodiments, the resin is a dual cure resin. Such resins are described in, for example, Rolland et al., U.S. Pat. Nos. 9,676,963; 9,598,606; and 9,453,142, the disclosures of which are incorporated herein by reference.

Resins may be in any suitable form, including “one pot” resins and “dual precursor” resins (where cross-reactive constituents are packaged separately and mixed together before use, and which may be identified as an “A” precursor resin and a “B” precursor resin).

Particular examples of suitable resins include, but are not limited to, Carbon, Inc. rigid polyurethane resin (RPU), flexible polyurethane resin (FPU), elastomeric polyurethane resin (EPU), cyanate ester resin (CE), epoxy resin (EPX), or urethane methacrylate resin (UMA), all available from Carbon, Inc., 1089 Mills Way, Redwood City, Calif. 94063 USA.

### 2. Window Cassettes.

In general, a window cassette or build plate for use in the present invention may comprise any suitable semipermeable or permeable material (that is, permeable to the polymerization inhibitor) including amorphous fluoropolymers, such as an amorphous thermoplastic fluoropolymer like TEFLON AF 1600™ or TEFLON AF 2400™ fluoropolymer films, or perfluoropolyether (PFPE), particularly a crosslinked PFPE film, or a crosslinked silicone polymer film. Beneath that may be a fluid bed layer, such as provided by a gas permeable material, optionally containing channels or cavities, such as a permeable polymer (e.g., poly(dimethylsiloxane) (PDMS). A base or support member (such as glass or sapphire) may be included at the bottom of the window if necessary, and may serve to further define the fluid supply bed. The build plate may be supported by a peripheral frame, with the two together forming a removable window cassette as discussed below.

In some embodiments, the pressure and gas supply to the build plate may be controlled to reduce bubble or voids formed by excess gasses, such as nitrogen, in the polymerizable fluid (e.g., resin) of in the 3D printing process and apparatus. Although the methods described herein may be performed by controlling a pressure and/or content of the gas supplied to the build plate using a pressure controller/gas supply, it should be understood that any suitable system may be used, including alternative build plates. For example, any permeable build plate may be positioned such that the side opposite the build surface is in a pressure-controlled chamber, or any suitable configuration of pressure-pressure controlled channels may be used.

The amount and duration of the reduced pressure applied to the polymerizable liquid through the optically transparent member is preferably sufficient to reduce a gas concentration in the polymerizable liquid. The pressure may be at 0%, 5%, 10%, 20%, 25%, 30%, 40% to 50%, 60%, 70%, 80%, 90% or 100% of atmospheric pressure. The oxygen or polymerization inhibitor gas composition of the gas supplied may be 20%, 25%, 30%, 40% to 50%, 60%, 70%, 80%, 90% or 100% oxygen.

In some embodiments, the polymerizable fluid has a gradient of gas concentration, which determines an amount of irradiation or “dose” to cure the polymerizable liquid. For example, the polymerizable fluid can have a lower region on the optically transparent member, and an upper region on the lower region opposite the optically transparent member such that the lower region has a higher dose to cure than the upper region. The applied reduced pressure to the polymerizable liquid through the optically transparent member may reduce a gas concentration in the upper region, while maintaining the polymerization inhibitor gas in the lower region, which consequently reduces a thickness of the dead zone. In some embodiments, the thickness of the lower region is less than about 1000 microns or between about 1, 2, 5, 10, 20 50, 100, 200 300 to 400, 500, 600, 700, 800, 900 or 1000 microns.

In some embodiments, oxygen gas may be used as the polymerization inhibitor. Oxygen may be supplied at any suitable pressure, and is preferably supplied at a pressure that is less than atmospheric pressure. In particular embodiments, the pressure of the oxygen is substantial equal to a partial pressure of oxygen in air at atmospheric pressure (e.g., 100% oxygen supplied at about 0.2 atm). The polymerization inhibitor gas may also be substantially devoid of nitrogen or other gases that do not substantially contribute to polymerization inhibition in the dead zone.

Without wishing to be bound by any particular theory, resins that are saturated with gas are prone to degassing when the local pressure drops. Large pressure drops can occur during the build platform movement and resin refill. When the separation of the printed part and window result in gas coalescence, voids may be formed in the printed part. Accordingly, controlling the pressure of a gas or applying a vacuum through the gas permeable build plate may reduce the level of dissolved gases prior to the pressure change, and reducing an amount of dissolved gas may increase the pressure differential that the resin can experience prior to void formation. The build plate is permeable to gasses, and equilibrium may be established at the build plate/resin interface relatively quickly. Cycling between air (or oxygen) and vacuum for printing formation and part movement, respectively, may permit the CLIP process to be performed with a maximum pressure differential on the resin prior to void formation the part. Moreover, the removal of nitrogen, which is not an active component of polymerization inhibition, may reduce the overall gas level and further reduce the formation of bubbles or voids in the printed part.

In addition, while oxygen delivery to the interface between the polymerizable fluid and the build plate is desirable, oxygen in the regions of the polymerization fluid that are further away from the interface may lead to a larger dosage of irradiation to cure the polymerizable fluid, which results in a longer exposure time and slower print speeds. Reducing the overall oxygen level may lead to faster cure times, by may lead to difficulty maintaining sufficient oxygen at the interface for the CLIP process to be effective. Moreover, since the light intensity decays as it passes through the polyermization fluid, the percent monomer to polymer conversions may not be constant throughout the exposed region. Controlling a level of oxygen concentration may reduce exposure times and increase print speeds by effectively maintaining a level of oxygen at the build plate and polymerization fluid interface. The oxygen concentration profile may also be controlled to provide more consistent percent monomer to polymer conversions in view of variations of light intensity.

Additional Build Plate Materials.

Any suitable material may be used to form the build plates described herein, including multi-layer build plates and/or build plates formed of more than one material. For example, the flexible layer (used alone or with additional supports or layers) may include a woven glass fabric (fiberglass or e-glass) with a crosslinked silicone elastomeric coating (such as room temperature vulcanized (RTV) silicone), which may be lightly infiltrated into the glass fiber fabric to provide mechanical durability. The oxygen permeability of silicone elastomer (rubber) is similar to Teflon® AF-2400. Such a configuration may be used alone or affixed (adhesively adhered) to a glass plate with the unfilled areas of the fabric available for air (oxygen) flow. Sulfonated tetrafluoroethylene based fluoropolymer-copolymers, such as Nafion® from Dupont may also be used.

In some embodiments, asymmetric flat sheet membranes which are currently used in very high quantity for water purification applications (see U.S. Patent Publication No. 2014/0290478) may be used. These membranes are generally polysulfone or polyethersulfone, and may be coated with perfluoropolymers or crosslinked silicone elastomer to increase chemical resistance. Also poly(vinylidene fluoride) and possibly polyimide asymmetric (porous) membranes may be used, for example, if chemical resistance is a problem. Some of the membranes may be used as is without coatings. Examples of such membranes include FilmTec® membranes (Dow Chemical, Midland, Mich. (USA)). These are porous polysulfone asymmetric membranes coated with a crosslinked high Tg polyamide (with a coating thickness of about 0.1 microns). The crosslinked polyamide coating should provide chemical resistance. Although the oxygen permeability of the polyamide is low, the thickness of the coating may be so low that the effective oxygen transmission rate is high. The polysulfone support without the polyamide layer could be coated with a wide variety of polymers such as silicone rubber (or AF-2400) to yield very high oxygen transmission. The FilmTec® membranes are produced in very high quantity as they are the prime material used in water desalination plants. PVDF porous membranes may allow repeated use.

Although embodiments according to the present invention are described with respect to flexible layers on the build plate that include a semipermeable (or gas permeable) member (e.g., perfluoropolymers, such as TEFLON AF® fluoropolymers, it should be understood that any suitable flexible material may be used in the configurations described herein. For example, a transparent, resilient paper, such as glassine, may be used. Glassine is a relatively transparent, greaseproof paper formed of well-hydrated cellulosic fibers that has been super calendared. Glassine may be plasticized and/or coated with wax or a glaze. Glassine may be gas permeable. In some embodiments, the glassine may be coated with a thin layer of crosslinked silicone elastomer or a perfluoropolymer, such as TEFLON AF® fluoropolymers. Glassine paper is substantially grease resistant, and may have limited adhesion to the polymerizable liquid described herein.

Build Plate Coatings.

Omniphobic surfaces may be used on the build plate surface or build region. For example, patterned surfaces (either a random array of particles or mircro patterned surfaces) that contain non-miscible fluids that are pinned or held to the surface by capillary forces may be used. Such a surface may result in fluid on the surface floating along the surface. Examples of such surfaces are described in U.S. Pat. Nos. 8,535,779 and 8,574,704, the disclosures of which are hereby incorporated by reference in their entireties.

Examples of build plates that can be modified based on the disclosure given herein for use in carrying out the present invention include, but are not limited to, those described in: U.S. Pat. No. 9,498,920 to J. DeSimone, A. Ermoshkin, and E. Samulski; U.S. Pat. No. 9,360,757 to J. DeSimone, A. Ermoshkin, N. Ermoshkin and E. Samulski; and U.S. Pat. No. 9,205,601 to J. DeSimone, A. Ermoshkin, N. Ermoshkin and E. Samulski; U.S. Patent Application Publication Nos. 2016/0046075 to J. DeSimone, A. Ermoshkin et al.; 2016/0193786 to D. Moore, A. Ermoshkin et al.; 2016/0200052 to D. Moore, J. Tumbleston et al.; PCT Patent Application Publication Nos. WO 2016/123499 to D. Moore, J. Tumbleston et al; WO 2016/123506 to D. Moore, J. Tumbleston et al.; WO 2016/149097 to J. Tumbleston, E. Samulski et al.; WO 2016/149014 to J. Tumbleston, E. Samulski et al.; and others (the disclosures of all of which are incorporated by reference herein in their entirety).

### 3. Example Apparatus and Methods.

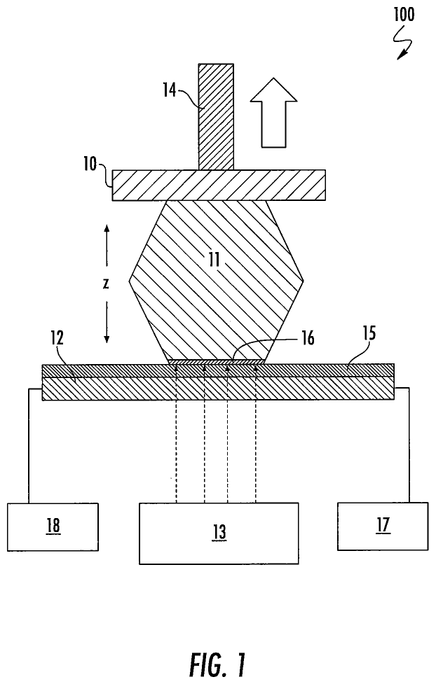

According to some embodiments, FIG. 1 shows a bottom-up stereolithography apparatus 100 for producing a three dimensional object by additive manufacturing. The apparatus 100 may include a light source 13 (e.g., a UV light source), a carrier 10, a window cassette 12, a drive assembly 14, and a fluid supply 17. In some embodiments, the apparatus 100 may optionally comprise a vacuum source 18. The carrier 10 may be positioned above the light source 13. A three dimensional object 11 may be produced on the carrier 10 from a polymerizable liquid or resin 15. The drive assembly 14 may be operatively associated with the carrier 10 and window cassette 12. The drive assembly 14 may be configured to advance the carrier 10 away from the window cassette 12 a distance z. In some embodiments, the window cassette 12 may be removable from the apparatus 100.

### 4. Bonded Assemblies and Related Methods

Manufacturers have adhesives for joining parts (e.g., polymer to a metal, such as a polymer bicycle seat to a composite shell; polymer to fabric, such as a midsole to an upper; polymer to polymer, such as a midsole to an outsole, etc.) that are validated for their particular parts and materials. When one part is replaced with an additively manufactured part, the adhesive may no longer be valid for the now additively manufactured part (though it is still valid for the other, preformed, part).

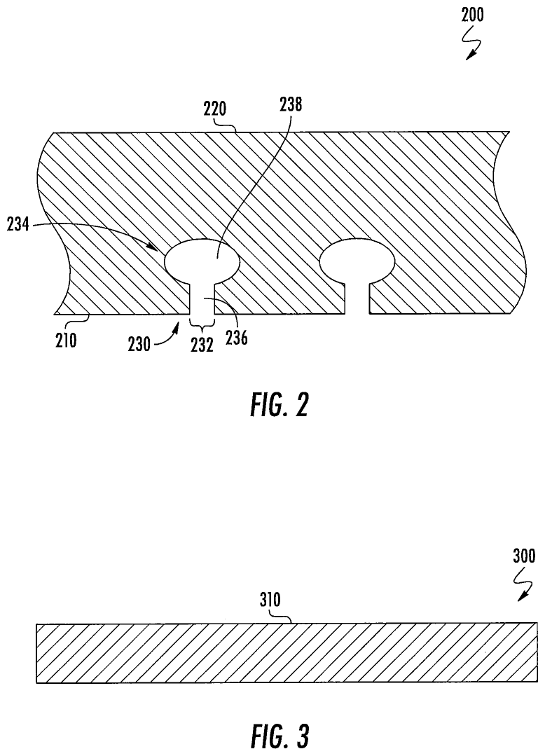

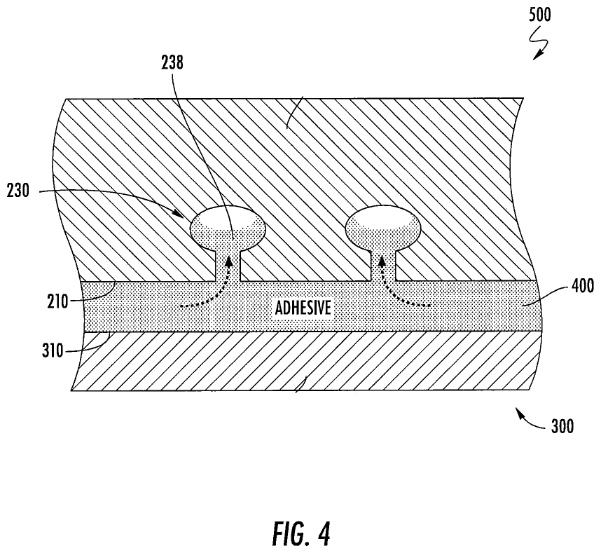

As shown in FIG. 2, an object 200 may be formed by the three-dimensional (3D) printing techniques described herein. The object 200 includes two opposing surfaces 210, 220 and locking orifices 230. The locking orifices 230 include an opening 232 on the surface 210 of the object 200 and a cavity 234 extending into the object 200. As illustrated, the cavity 234 includes a channel 236 and a reservoir 238. As shown in FIG. 3, another object 300 having a surface 310 is shown. As illustrated in FIG. 4, the bonded assembly 500 is formed when an adhesive 400 is positioned between the object 200 and the object 300. The adhesive 400 may be applied to the surface 210 and/or 310 of the objects 200, 300, and pressure may be applied so that the adhesive 400 flows into the plurality of locking orifices 230. The adhesive 400 may flow through the channel 236 and into the reservoir 238 of the cavity 234. The adhesive 400 may fully or partially fill the orifices 230. The adhesive 400 may be cured, for example, by heat and/or drying, to form the bonded assembly 500.

As illustrated, the pores or orifices 230 can have expanded internal cavities 234 into which adhesive 400 can flow. When adhesive is applied and the parts or objects are pressed together, adhesive flows into the cavities and—when dried or cured—physically locks the parts in place. The internal cavities need not be completely filled, as long as sufficient adhesive flows in to create a locking segment in the dried or cured adhesive.

As illustrated, the cross section of the cavity 234 (e.g., at the reservoir 238) is greater than a cross section of the opening 232 of the locking orifices 230. In this configuration, the surface 210 may maintain a larger area while the orifices 230 may provide sufficient volume to accommodate the adhesive 400 therein. In some embodiments, when the object 200 is formed by a 3D printing process, such as by the apparatus 100, the surface 210 is positioned adjacent the carrier 10. Therefore, the openings 232 may be sized so as to permit a sufficiently large planar area of the surface 210 to adhere the surface 210 to the carrier 10 during printing. In particular embodiments, the openings 232 may be from 1, 3, 5, 7, 10 mm to 1 or 2 cm.

In some embodiments, the adhesive comprises an adhesive selected from the group consisting of polymer adhesives, epoxy adhesives, cyanoacrylate adhesives, polyurethane adhesives, silicone adhsives and combinations thereof. Commercially available adhesives include 3M Scotch Weld, Loctite Family of adhesives from Henkel: Epoxy, silicone, Hysol Gorilla Glue, A-12 and Modge Podge.

In some embodiments, the object 200 is a partially cured object, and when the adhesive 400 is cured to form the bonded assembly 500, the object 200 is further cured, which may increase bonding with the adhesive 400.

Accordingly, manufacturers have adhesives for joining parts (e.g., polymer to a metal, such as a polymer bicycle seat to a composite shell; polymer to fabric, such as a midsole to an upper; polymer to polymer, such as a midsole to an outsole, etc.) that are validated for their particular parts and materials. When one part is replaced with an additively manufactured part, the adhesive may no longer be valid for the now additively manufactured part (though it is still valid for the other, preformed, part). A solution is to create pores or orifices in the printed parts on the surfaces to be adhered, the orifices being sufficiently large to wash after printing. As shown in FIG. 4, the orifices 230 can have expanded internal cavities 234 into which adhesive 400 can flow (arrows below). When adhesive is applied and the parts pressed together, adhesive flows into the cavities and—when dried or cured—physically locks the parts or objects 200, 300 in place. The internal cavities 234 need not be completely filled, as long as sufficient adhesive flows in to create a locking segment in the dried or cured adhesive.

The bonded assembly 400 may be used to bond any suitable components. In some embodiments, additional orifices may be provided on the surface 220 and another object may be bonded to the surface 220. Thus, the orifices may be provided on opposing surfaces of an object to provide an adhesive interface between two objects.

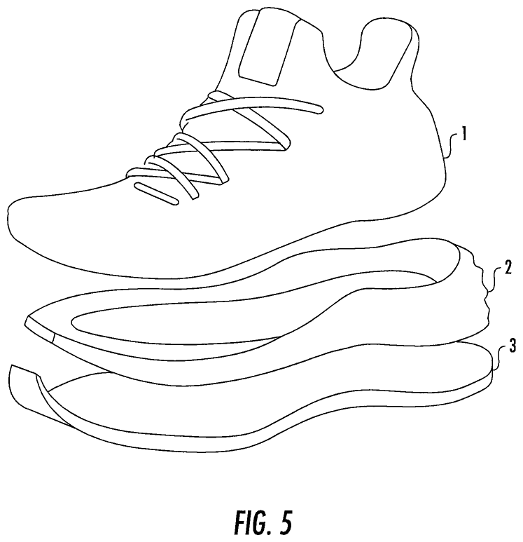

As illustrated in FIG. 5, a shoe assembly is showin including an upper 1, a midsole 2 and a sole 3. The midsole 2 may be an additively manufactured midsole, and may include orifices as described herein on the surfaces facing the upper 1 and the sole 3. An adhesive may be positioned between the upper 1 and the midsole 2 and between the midsole 2 and the sole 3. The adhesive may flow into orifices on the midsole 2 and be adhesively bonded as described with respect to FIG. 4.

Any suitable structure may be bonded together as described herein. For example, in some embodiments, the bonded objects that form the bonded assembly may form a dual-material cushion with the first object comprising an additively manufactured lattice structure (with the orifices formed on a surface thereof) and the second object comprising foam that is bonded to the additively manufactured lattice structure by an adhesive/orifice interface. The dual-material padding may be sized and configured to provide cushioning material for a helmet.

In some embodiments, the object of the bonded assembly having the orfices on a surface thereof may be formed as a protective layer (e.g., a bumper or padding).

In some embodiments, the object of the bonded assembly having the orfices on a surface thereof may be formed as a cushioning lattice structure and the other object may be a base (e.g., a bike handle grip, a bike seat, a grip cushion for a camera). The base may be a polymer to compo

In some embodiments, the additively manufactured object with the orifices (e.g., object 200) is formed of a polymer and is adhered to an object (e.g., object 300) that may be formed of a different material, such as metal, a composite, polymer, or composite carbon fiber. For example, polymer additively manufactured objects may be attached to vehicle panels, such as interior polymer components that may be attached to a metal (aluminum) automobile door.

The foregoing is illustrative of the present invention, and is not to be construed as limiting thereof. The invention is defined by the following claims, with equivalents of the claims to be included therein.

We claim:

1. A method of forming a bonded assembly, the method comprising:
providing a first object comprising a first surface having a plurality of locking orifices formed therein, each of the plurality of locking orifices including an opening on the surface of the object and a cavity extending in the first object;
positioning an adhesive on at least one of the first surface of the first object and a second surface on a second object;
positioning the first surface of the first object on the second surface of the second object with the adhesive between the first and second surfaces; and
curing the adhesive to form the bonded assembly.

2. The method of claim 1, further comprising applying pressure such that the adhesive flows into the plurality of locking orifices prior to curing the adhesive.

3. The method of claim 2, wherein the adhesive flows into the cavity extending in the first object.

4. The method of claim 1, wherein a cross section of the cavity is greater than a cross section of the opening of the plurality of locking orifices.

5. The method of claim 1, wherein each of the plurality of locking cavities comprises a channel connecting the opening to the cavity, wherein a cross section of the cavity is greater than a cross section of the channel.

6. The method of claim 1, wherein the adhesive comprises an adhesive selected from the group consisting of polymer adhesives, epoxy adhesives, cyanoacrylate adhesives, polyurethane adhesives, silicone adhesives and combinations thereof.

7. The method of claim 1, wherein the first object is a partially cured object, and wherein curing the adhesive to form the bonded assembly further comprises further curing the first object.

8. The method of claim 1, wherein the bonded assembly comprises a dual-material cushion with the first object comprising a 3D printed lattice structure and the second object comprising foam.

9. The method of claim 8, wherein the dual-material padding comprising the first and second object is sized and configured to provide cushioning material for a helmet.

10. The method of claim 1, wherein the first object of the assembly comprises a protective layer.

11. The method of claim 10, wherein the protective layer comprises a protective bumper or padding.

12. The method of claim 1, wherein the first object comprises a cushioning lattice structure and the second object comprises a base.

13. The method of claim 12, wherein the base comprises a bike handle grip, a bike seat or a grip cushion.

14. The method of claim 1, wherein the first object is a shoe midsole and the second object is a shoe upper or a shoe sole.

15. The method of claim 1, wherein the first object comprises first and second opposing sides, and the plurality of locking orifices is on a first side of the first object.

16. The method of claim 15, wherein the plurality of locking orifices is further on the second side of the first object, the method further comprising positioning the adhesive on at least one of the second side of the first object and a third surface on a third object such that the adhesive is cured between the first object and the third object to provide the bonded assembly.

17. The method of claim 1, wherein the first object comprises a three-dimensional printed object.

18. A bonded assembly comprising:
a first object comprising a first surface having a plurality of locking orifices formed therein, each of the plurality of locking orifices including an opening on the surface of the object and a cavity extending in the first object;
a second object comprising a second surface;
an adhesive between the first and second surfaces, the adhesive extending in the plurality of locking orifices.

19. The bonded assembly of claim 18, wherein the adhesive comprises an adhesive selected from the group consisting of polymer adhesives, epoxy adhesives, cyanoacrylate adhesives, polyurethane adhesives, silicone adhesives and combinations thereof.
